(19) United States
(12) Patent Application Publication
(10) Pub. No.: US 2022/0001781 A1
(43) Pub. Date: Jan. 6, 2022

(54) VEHICLE SEAT

(71) Applicant: Faurecia Autositze GmbH, Stadthagen (DE)

(72) Inventor: Andreas SPORMANN, Kelheim (DE)

(21) Appl. No.: 17/365,212

(22) Filed: Jul. 1, 2021

(30) Foreign Application Priority Data
Jul. 2, 2020 (DE) 20 2020 103 825.7

(51) Int. Cl. B60N 2/72; B60N 2/70; B60N 2/02

(52) U.S. Cl. CPC B60N 2/72; B60N 2002/026; B60N 2/0244; B60N 2/7094

(57) ABSTRACT

The present disclosure relates to a vehicle seat including upholstery elements and at least one damping arrangement in at least one der upholstery element, the damping arrangement comprising at least one mechanically acting spring element and a pneumatically acting bubble associated with the spring element, the bubble comprising an interior space and an elastic bubble wall, where a pressure in the interior space of the bubble can be variably adjusted via a pump, the spring element and the bubble acting in collaboration with the at least one upholstery element in such a manner that a damping of the respective upholstery element depends on a restoring force of the spring element and the pressure in the bubble.

### PRIORITY CLAIM

This application claims priority to German Patent Application No. DE 20 2020 103 825.7, filed Jul. 2, 2020, which is expressly incorporated by reference herein.

### BACKGROUND

The present disclosure relates to a vehicle seat, more particularly to a vehicle seat having a damping arrangement.

### SUMMARY

According to the present disclosure, a vehicle seat includes a damping arrangement where the damping of an upholstery element of the vehicle seat can be adjusted comfortably and with a high degree of variability.

In illustrative embodiments, a bubble of the damping arrangement is disposed in the damping arrangement in the direction of deflection of a spring element of the damping arrangement above or below the spring element, preferably immediately above or below thereof. Thus, a serial construction or, respectively, an in-line arrangement of pneumatic bubble and mechanical spring element is attained so that a pneumatic operating principle is combined with a mechanical operating principle.

In illustrative embodiments, the bubble is able to selectively influence the damping effect of the spring thereby realizing a comfortable damping adjustment with a high degree of variability.

In illustrative embodiments, one starts from a vehicle seat with upholstery elements, e.g. seating parts, back rests, head rests, arm rests, etc., where at least one damping arrangement is disposed in at least one of the upholstery elements, the damping arrangement comprising at least one, preferably at least two mechanically acting spring element(s), e.g. a spiral spring, and a pneumatically acting bubble associated with the spring element, where the bubble comprises an interior space and an elastic bubble wall, where a pressure in the interior space of the bubble and, thereby, also a volume of the bubble can be variably adjusted by means of a pump.

In illustrative embodiments, the spring element and the bubble act in conjunction with the at least one upholstery element in such a manner that a damping or, respectively, a resilience or a rigidity of the respective upholstery element depend on a restoring force of the spring element and the pressure in the bubble.

In illustrative embodiments, the bubble collaborates with the spring element in such a manner that a change in pressure in the interior space of the bubble results in a deflection of the spring element or, respectively, a bias and, therewith, in a change of the restoring force so as to variably adjust the damping of the at least one upholstery element as a function of the pressure inside the bubble. Thus, the damping of the respective upholstery element is changed in that a bias of the spring element is purposefully increased or reduced. This can happen continuously so that the damping can be influenced in a variable manner.

In illustrative embodiments, the pressure in each bubble of the damping arrangement can be adjusted individually and/or temporally modifiable, preferably via a pump and/or valves individually associated with the bubbles. This allows the damping to be selectively adjusted at different positions of the respective upholstery element so as to, for example, react to different driving situations and/or adjust the comfort depending on the occupant.

In illustrative embodiments, the spring element faces towards a surface of the respective upholstery element, the surface serving as a rest for the occupant, and the bubble towards an upholstery bowl of the respective upholstery element, the upholstery bowl serving to receive a foam part for cushioning the respective upholstery element. Thus, the restoring force of the spring element can act with a higher degree of efficiency on the surface via which the occupant perceives the damping effect. To improve this, it may be provided, that the direction of deflection of the spring element is perpendicular to the respective surface.

In illustrative embodiments, it is also possible to provide a reverse construction in which in the serial design of the damping arrangement it is the bubble that faces the surface while the spring element faces the upholstery bowl.

In illustrative embodiments, each bubble acts, in particular, immediately, upon merely one spring element. This allows the effect of each spring element to be adjusted individually, thereby increasing the variability.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a vehicle seat having a plurality of damping arrangements;

FIG. 2 shows a detailed view of a damping arrangement according to FIG. 1; and

FIG. 3a-d shows different adjustments of the damping arrangement.

### DETAILED DESCRIPTION

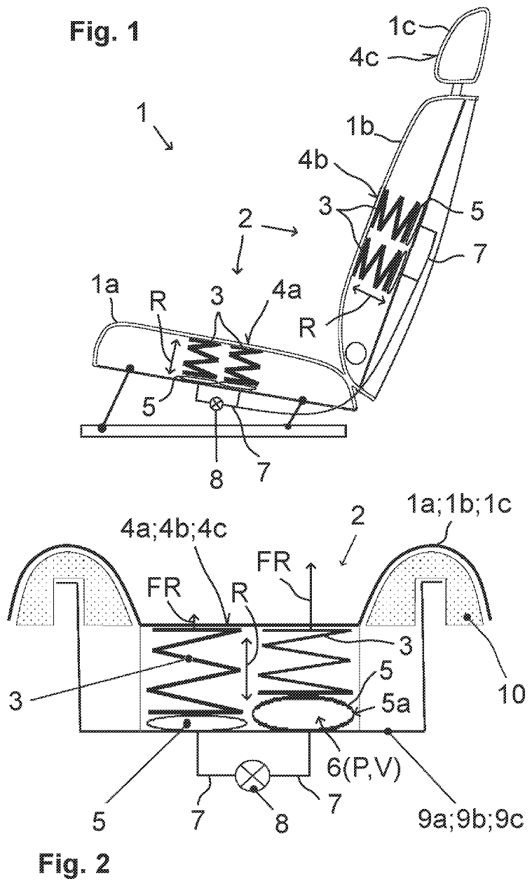

FIG. 1 shows a schematic representation of a vehicle seat 1 with a cushioned seating part 1a and a cushioned back rest 1b. A damping arrangement 2 is integrated into the seating part 1a as well as into the back rest 1b. Also, further damping arrangements 2 may be integrated into in a cushioned head rest 1c and/or cushioned arm rests (not shown) or further upholstery elements of the vehicle seat 1. According to FIG. 2, the damping arrangement 2 is embedded in a foam part 10 of the respective upholstery element 1a, 1b, 1c of the vehicle seat 1.

According to the embodiment variant schematically represented in FIG. 2, each damping arrangement 2 comprises two mechanical spring elements 3, for example spiral springs that extend parallel to one another and whose direction of deflection R is oriented perpendicular to a seating surface 4a of the seating part 1a or, respectively, perpendicular to a back surface 4b of the back rest 1b. When arranged inside the head rest 1c the direction of deflection R is correspondingly aligned perpendicular to a head surface 4c. Hereby, direction of deflection R is understood to mean the direction into which the spring element 3 is deflected under the influence of a force from its rest position. Thus, a restoring force FR also acts into the direction of deflection R when the spring element 3 is biased in any way (compressed, extended).

In principle, it is possible for the direction of deflection R of the spring elements 3 to be aligned non-perpendicular to the seating surface 4a or, respectively back surface 4b or head surface 4c so that only a fraction of the restoring force FR acts perpendicular onto the seating surface 4a or the back surface 4b or the head surface 4c respectively. Further, it is possible for the damping arrangement 2 to comprise merely one spring element 3 or more than two spring elements 3.

One bubble 5 is associated with each mechanical spring element 3 in the damping arrangement 2, the bubble abutting the mechanical spring element 3 and collaborating therewith. Each bubble 5 comprises an air-tight interior space 6 which is surrounded by elastic bubble walls 5a. The interior space 6 of each bubble 5 can be ventilated or deflated selectively and individually so as to change a pressure P within the bubble 5. To that end, the interior space 6 of each bubble 5 is connected via an air duct 7 to a central pump 8 which is disposed, for example, on the vehicle seat 1 or in the vicinity of the vehicle seat 1. Hereby, the ventilation and deflation of the respective interior space 6 may be controlled either centrally by the pump 8 or individually by valves (not shown) associated with the bubbles 5.

Due to the elasticity of the bubble walls 5a any change in pressure simultaneously results a change in volume V of the bubble 5 or the interior space 6 respectively, i.e. the bubble 5 expands or constricts. This also causes a deflection of the respectively associated mechanical spring element 3 because the bubble 5 abuts on these or, respectively, collaborates with them. Thus, the deflection of the spring element 3 follows the expansion of the bubble 5. Preferably, hereby, the bubble 5 is in immediate contact with the respective spring element 3 in the direction of deflection R of that spring element 3 so that the change in volume V der bubble 5 is transmitted into a deflection of the spring element 3 in an efficient manner.

Thus, by virtue of this “serial” arrangement of the spring elements 3 and the respectively associated bubble 5, it is possible to couple the pneumatically generated expansion of the bubble 5 with the mechanical deflection of the spring element 3. This allows a purposeful adjustment of a rigidity or flexibility respectively of the seating part 1a or, respectively, the back rest 1b or the head rest 1c as follows:

In the representations in FIG. 1 and FIG. 2 the respective spring element 3 of the seating surface 4a or of the back surface 4b or the head surface 4c respectively and the bubble 5 each face a back side upholstery bowl 9a, 9b, 9c of the seating part 1a or of the back rest 1b or of the head rest 1c respectively. Hereby, the bubble 5 indirectly or directly rests on the respective back side upholstery bowl 9a, 9b, 9c while the respective spring element 3 can be indirectly or directly pressed against the seating surface 4a or back surface 4b or head surface 4c respectively by a restoring force FR in the direction of deflection R. Hereby, the restoring force FR of the spring elements 3 determines which force acts on the seating surface 4a or the back surface 4b or the head surface 4c respectively and, therewith, the damping effect of the seating surface 4a or the back surface 4b or the head surface 4c respectively, as perceived by the occupant resting against it.

In principle, a reverse design is also possible, i.e. the bubble 5 facing towards the respective surface 4a, 4b, 4c and the spring element 3 resting against the respective back side upholstery bowl 9a, 9b, 9c. The restoring force FR of the spring elements 3 will then press the bubble 5 disposed above in the direction of deflection R against the respective surface 4a, 4b, 4c, so as to attain the corresponding damping effect.

When the bubble 5 is deflated, as shown in FIG. 2 for the left bubble 5, this results in a low pressure P in the interior space 6. By way of example only, let it be assumed that the spring element 3 in this case is only slightly biased, i.e. only insignificantly deflected from its rest position. In principle, the spring element 3 may even be in its rest position when the bubble 5 is completely deflated. In the case of a slight bias there will be a weak restoring force FR resulting from which is a certain damping effect, for example, corresponding to a high flexibility or, respectively, a low rigidity of the seating part 1a of the back rest 1b respectively.

When the bubble 5 is inflated by the pump 8 or, respectively loaded with high pressure P, as shown in FIG. 2 for the right bubble 5, this will result in an expansion of the volume V of the bubble 5, thereby further biasing or, respectively, deflecting the spring element 3 from its rest position. The increased restoring force FR on the seating surface 4a or, respectively, the back surface 4b resulting there from results in a decreased flexibility or respectively, a higher rigidity of the seating part 1a or the back rest 1b or the head rest 1c respectively. Thus, by means of the pressure P in the bubble 5, it is possible to variably adjust the damping effect perceived by the occupant.

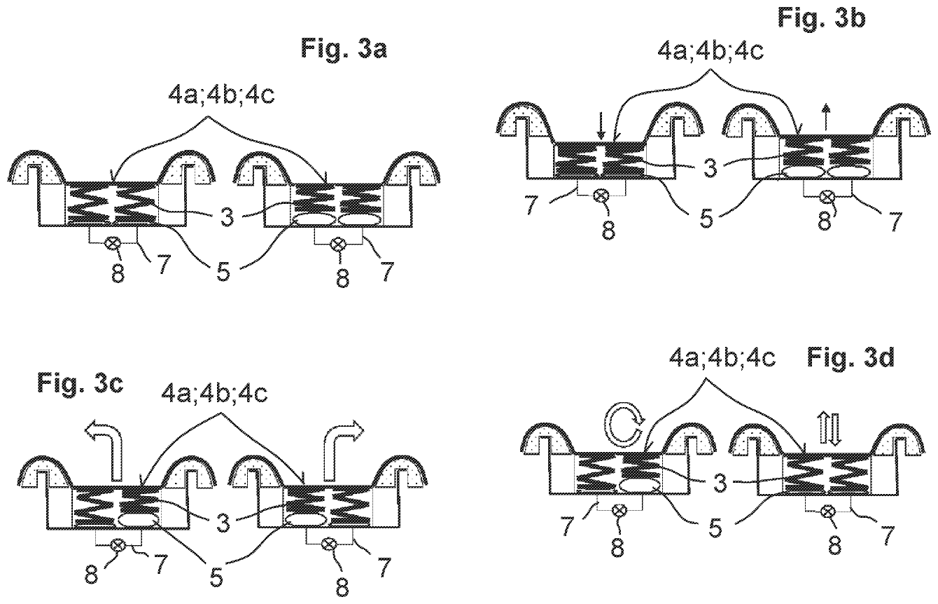

According to FIGS. 3a-d, using damping arrangements 2 of this type, it is possible to individually adjust different damping effects in the seating part 1a and/or in the back rest 1b and/or the head rest 1c. In addition, suitable existing damping arrangements 2 in the arm rests or further upholstery elements of the vehicle seat 1 may be utilized also.

Thus, according to FIG. 3a, it is provided, using the damping arrangement 2 to deflate (left side) or inflate (right side) both bubbles 5 to generate a soft (left side) or, respectively, hard (right side) surface 4a, 4b, 4c and thereby to attain a high (left side) or, respectively, low (right side) flexibility and damping effect across the entire surface 4a, 4b, 4c of the seating part 1a or the back rest 1b or the head rest 1c respectively. The adjustment can be made, for example, in response to a property of the ground on which the vehicle moves. Thus, it is possible to adjust a high damping effect for an uneven, irregular surface of the ground and a slight damping effect for a smooth, level surface of the ground. This will lead to a more or less consistent perception for the occupant sitting in the vehicle seat 1.

However, it is also possible to utilize the adjustment generally for a user adapted increase of comfort. Thus, for example, the occupant may desire a softer or a harder surface 4a, 4b, 4c for lying or sitting depending on an inclination position (sitting upright or recumbent) of the back rest 1b and/or the driving mode (manual/autonomous) of the vehicle.

According to FIG. 3b, by adjusting the pressure P in the bubbles 5 it is also possible to selectively control a variable lowering (left side) or raising (right side) of the respective surface 4a, 4b, 4c so as to change a seating position. Furthermore, the adjustment of the pressure P in the bubbles 5 can be used to react to the weight of an occupant. In case of a heavy occupant the bias of the spring elements 3 may be increased by inflating the bubbles 5 so that the occupant will sink less into the respective surface 4a, 4b, 4c. In case of a lighter occupant a lesser bias on the spring elements 3 and, correspondingly, a lower pressure P is needed to achieve the same degree of sinking-in.

Further, according to FIG. 3c, the bubbles 5 may be controlled individually for each side, which may be carried out, for example, depending on a trip with curves. In a left turn (left side), for example, merely the right bubble 5 and in a right turn (right side) merely the left bubble 5 may be ventilated. This way, only the spring elements 3 on the outside of the curve are biased stronger, so as to react to or, respectively, selectively counteract an automatic movement of the occupant during the turn.

According to FIG. 3d, it is possible to generate a massage function by selectively adjusting the pressure P in den bubbles 5. To that end, the pressure P can be changed repetitively as a function of time, in particular, individually for each side (left side in FIG. 3d) or similarly on both sides (right side in FIG. 3d). Hereby, an alternating massage and/or a vibration effect on the occupant may be attained.

Aside from the afore-mentioned exemplary applications further adjustments of the pressure P are possible to purposefully cause a change in the damping effect of the respective surfaces 4a, 4b, 4c.

Seats, in particular vehicle seats, may comprise foam filled upholstery elements, in particular, seating parts, back rests, head rests, arm rests, etc. Due to the shape and structure of the foam material, these provide a certain degree of cushioning. In addition, mechanically acting spring elements, for example spiral springs, may be integrated in the upholstery elements, making for additional dampening. Because the dampening properties of a mechanical spring element are fixed it is not possible to change the dampening effect of the respective upholstery element without additional equipment.

In order to address this, comparative damping arrangements in upholstery elements may comprise, besides a mechanically acting spring element, a pneumatically acting bubble associated with the spring element, the bubble comprising an interior space and an elastic bubble wall, whereby a pressure in the interior space in of the bubble can be variably adjusted by means of a pump. Then, the (mechanical) spring element and the (pneumatic) bubble collaborate with the at least one upholstery element in such a way that a damping or resilience respectively or a rigidity of the respective upholstery element depend both on a restoring force of the spring element and the pressure in the bubble. It is a disadvantage that the spring element and the bubble are operated in parallel with one another.

The present disclosure provides a vehicle seat having a damping arrangement where the damping of an upholstery element of the vehicle seat can be adjusted comfortably and with a high degree of variability.

The present disclosure provides that a bubble of the damping arrangement is disposed in der damping arrangement in the direction of deflection of a spring element of the damping arrangement above or below the spring element, preferably immediately above or below thereof. Thus, a serial construction or, respectively, an in-line arrangement of pneumatic bubble and mechanical spring element is attained so that a pneumatic operating principle is combined with a mechanical operating principle. Hereby, the bubble is able to selectively influence the damping effect of the spring thereby realizing a comfortable damping adjustment with a high degree of variability.

Hereby, one starts from a vehicle seat with upholstery elements, e.g. seating parts, back rests, head rests, arm rests, etc., where at least one damping arrangement is disposed in at least one of the upholstery elements, the damping arrangement comprising at least one, preferably at least two mechanically acting spring element(s), e.g. a spiral spring, and a pneumatically acting bubble associated with the spring element, where the bubble comprises an interior space and an elastic bubble wall, where a pressure in the interior space of the bubble and, thereby, also a volume of the bubble can be variably adjusted by means of a pump. Hereby, the spring element and the bubble act in conjunction with the at least one upholstery element in such a manner that a damping or, respectively, a resilience or a rigidity of the respective upholstery element depend on a restoring force of the spring element and the pressure in the bubble.

It is further provided that the bubble collaborates with the spring element in such a manner that a change in pressure in the interior space of the bubble results in a deflection of the spring element or, respectively, a bias and, therewith, in a change of the restoring force so as to variably adjust the damping of the at least one upholstery element as a function of the pressure inside the bubble. Thus, the damping of the respective upholstery element is changed in that a bias of the spring element is purposefully increased or reduced. This can happen continuously so that the damping can be influenced in a variable manner.

In addition hereto, the present disclosure provides that the pressure in each bubble of the damping arrangement can be adjusted individually and/or temporally modifiable, preferably via a pump and/or valves individually associated with the bubbles. This allows the damping to be selectively adjusted at different positions of the respective upholstery element so as to, for example, react to different driving situations and/or adjust the comfort depending on the occupant.

It is further provided that the spring element faces towards a surface of the respective upholstery element, the surface serving as a rest for the occupant, and the bubble towards an upholstery bowl of the respective upholstery element, the upholstery bowl serving to receive a foam part for cushioning the respective upholstery element. Thus, the restoring force of the spring element can act with a higher degree of efficiency on the surface via which the occupant perceives the damping effect. To improve this, it may be provided, that the direction of deflection of the spring element is perpendicular to the respective surface.

In principle, however, it is also possible to provide a reverse construction in which in the serial design of the damping arrangement it is the bubble that faces the surface while the spring element faces the upholstery bowl.

It is further provided that each bubble acts, in particular, immediately, upon merely one spring element. This allows the effect of each spring element to be adjusted individually, thereby increasing the variability.

The present disclosure relates to a vehicle seat (1) including upholstery elements (1a; 1b; 1c) and at least one damping arrangement (2) in at least one der upholstery element (1a; 1b; 1c), the damping arrangement (2) comprising at least one mechanically acting spring element (3) and a pneumatically acting bubble (5) associated with the spring element (3), the bubble (5) comprising an interior space (6) and an elastic bubble wall (5a), where a pressure (P) in the interior space (6) of the bubble (5) can be variably adjusted via a pump (8), the spring element (3) and the bubble (5) acting in collaboration with the at least one upholstery element (1a; 1b; 1c) in such a manner that a damping of the respective upholstery element (1a; 1b; 1c) depends on a restoring force (FR) of the spring element (3) and the pressure (P) in the bubble (5).

The present disclosure provides that the bubble (5) is disposed in the damping arrangement (2) above or below the spring element (3) in the direction of deflection (R) of the spring element (3) and the pressure (P) in each bubble (5) of the damping arrangement (2) can be individually adjusted.

The following numbered clauses include embodiments that are contemplated and non-limiting:

Clause 1. A vehicle seat (1) including upholstery elements (1a; 1b; 1c) and at least one damping arrangement (2) in at least one of the upholstery elements (1a; 1b; 1c), the damping arrangement (2) comprising at least one mechanically acting spring element (3) and a pneumatically acting bubble (5) associated with the spring element (3), the bubble (5) comprising an interior space (6) and an elastic bubble wall (5a), whereby a pressure (P) in the interior space (6) of the bubble (5) can be variably adjusted via a pump (8),

the spring element (3) and the bubble (5) acting in collaboration with the at least one upholstery element (1a; 1b; 1c) in such a manner that a damping of the respective upholstery element (1a; 1b; 1c) depends on a restoring force (FR) of the spring element (3) and the pressure (P) in the bubble (5),

characterized in that the bubble (5) is disposed in der damping arrangement (2) above or below the spring element (3) in the direction of deflection (R) of the spring element (3) and the pressure (P) in each bubble (5) of the damping arrangement (2) can be individually adjusted.

Clause 2. The vehicle seat (1) according to clause 1, characterized in that the bubble (5) acting in collaboration with the spring element (3) in such a manner that a change in pressure (P) in the interior space (6) of the bubble (5) causes a deflection of the spring element (3) and, thereby, a change in the restoring force (FR) for variably adjusting the damping der of the at least one upholstery element (1a; 1b; 1c) depending on the pressure (P) in the bubble (5).

Clause 3. The vehicle seat (1) according to clause 1 or 2, characterized in that the pressure (P) in each bubble (5) of the damping arrangement (2) can be individually adjusted in a temporally adjustable manner.

Clause 4. The vehicle seat (1) according to one of the above clauses, characterized in that the pressure (P) in each bubble (5) of the damping arrangement (2) can be individually adjusted via a pump (8) and/or valves associated with the bubbles (5).

Clause 5. The vehicle seat (1) according to one of the above clauses, characterized in that the spring element (3) faces towards a surface (4a; 4b; 4c) of the respective upholstery element (1a; 1b; 1c), where the surface (4a; 4b; 4c) serves as a rest for an occupant, and the bubble (5) towards an upholstery bowl (9a; 9b; 9b) of the respective upholstery element (1a; 1b; 1c), the upholstery bowl (9a; 9b; 9c) serving to receive a foam part (10) for cushioning the respective upholstery element (1a; 1b; 1c).

Clause 6. The vehicle seat (1) according to clause 5, characterized in that the direction of deflection (R) of the spring element (3) is perpendicular to the respective surface (4a; 4b; 4c).

Clause 7. The vehicle seat (1) according to one of the above clauses, characterized in that each bubble (5) acts on only one spring element (3).

Clause 8. The vehicle seat (1) according to one of the above clauses, characterized in that the spring element (3) is a spiral spring.

Clause 9. The vehicle seat (1) according to one of the above clauses, characterized in that at least two spring elements (3) and at least two bubbles (5) associated with the spring elements (3) are provided in one damping arrangement (2).

Clause 10. The vehicle seat (1) according to one of the above clauses, characterized in that the bubble (5) abuts the spring element (3) immediately above or below in the direction of deflection (R).

Clause 11. The vehicle seat (1) according to one of the above clauses, characterized in that the at least one upholstery element is a seating part (1a) and/or a back rest (1b) and/or a head rest (1c) and/or an arm rest of the vehicle seat (1).

1. A vehicle seat comprising
upholstery elements and
at least one damping arrangement in at least one of the upholstery elements, the damping arrangement comprising at least one mechanically acting spring element and a pneumatically acting bubble associated with the spring element, the bubble comprising an interior space and an elastic bubble wall,
wherein a pressure in the interior space of the bubble can be variably adjusted via a pump, the spring element and the bubble acting in collaboration with the at least one upholstery element in such a manner that a damping of the respective upholstery element depends on a restoring force of the spring element and the pressure in the bubble,
wherein the bubble is disposed in the damping arrangement above or below the spring element in the direction of deflection of the spring element and the pressure in each bubble of the damping arrangement can be individually adjusted.

2. The vehicle seat of claim 1, wherein the bubble acting in collaboration with the spring element in such a manner that a change in pressure in the interior space of the bubble causes a deflection of the spring element and, thereby, a change in the restoring force for variably adjusting the damping the of the at least one upholstery element depending on the pressure in the bubble.

3. The vehicle seat of claim 1, wherein the pressure in each bubble of the damping arrangement can be individually adjusted in a temporally adjustable manner.

4. The vehicle seat of claim 1, wherein the pressure in each bubble of the damping arrangement can be individually adjusted via a pump and/or valves associated with the bubbles.

5. The vehicle seat of claim 1, wherein the spring element faces towards a surface of the respective upholstery element, where the surface serves as a rest for an occupant, and the bubble towards an upholstery bowl of the respective upholstery element, the upholstery bowl serving to receive a foam part for cushioning the respective upholstery element.

6. The vehicle seat of claim 5, wherein the direction of deflection of the spring element is perpendicular to the respective surface.

7. The vehicle seat of claim 1, wherein each bubble acts on only one spring element.

8. The vehicle seat of claim 1, wherein the spring element is a spiral spring.

9. The vehicle seat of claim 1, wherein at least two spring elements and at least two bubbles associated with the spring elements are provided in one damping arrangement.

10. The vehicle seat of claim 1, wherein the bubble abuts the spring element immediately above or below in the direction of deflection.

11. The vehicle seat of claim 1, wherein the at least one upholstery element is a seating part and/or a back rest and/or a head rest and/or an arm rest of the vehicle seat.
